(19) United States
(12) Patent Application Publication
(10) Pub. No.: US 2012/0138518 A1
(43) Pub. Date: Jun. 7, 2012

(54) FILTERING SYSTEM FOR SWIMMING POOLS

(76) Inventor: Filippo Bussinelli, Zevio (VR) (IT)

(21) Appl. No.: 13/390,176

(22) PCT Filed: Jul. 9, 2010
(86) PCT No.: PCT/IB2010/053153

§ 371 Date: Feb. 13, 2012

(30) Foreign Application Priority Data
Aug. 14, 2009 (IT) VR2009A000124

(51) Int. Cl. C02F 1/00

(52) U.S. Cl. 210/167.1; 210/170.07; 210/170.03

(57) ABSTRACT

A natural filtering system for the treatment of swimming pool water and/or treatment processes in other applications involving the use of water (aqueducts, wells, drinking water purification plant, filtering plant for the collection of rain water, etc.), which can be installed inside compensation tanks in the case of swimming pools or in storage tanks or decantation tanks for other applications, and where the compensation tank (26) is filled with a filtering mass (14), comprising microparticles of high-efficiency quartz sand or similar or other material suitable for treating water, and where the mass is supported by at least one plate (15) extending over the entire surface of the compensation tank, and where the plate rests on at least one micromesh net made from high-density polyethylene, and where the water in the compensation tank (26) is purified by gravity-fed sprays (12) and by feeding stabilised and non-stabilised disinfectants (22) and pH correctors (23) into the compensation tank.

### RELATED APPLICATION

The present application claims priority from Italian Patent Application Number VR2009A000124 filed on Aug. 14, 2009, the contents of which are incorporated herein by reference.

### BACKGROUND

1. Field

The present invention relates to a filtering system for swimming pools or other plant which use water.

In particular, the present invention refers to a filtering system for swimming pools whose purpose is to enable the natural filtration of swimming pool water by gravity and by using electric pumps to draw the water from the circuits provided for this purpose inside the compensation tank.

In this way the water drawn by the electric pumps follows a natural filtering path through a mass of sand and then through filters.

The filtering system according to the present invention makes it possible, in the presence of stabilised disinfectants such as chlorine or similar, to maintain the levels of combined chlorine present to within regulatory limits and therefore avoids the need to treat the water with oxidising products or to drain off large amounts of swimming pool water which then has to be replaced with fresh water from the main public supply network, private wells or other sources.

This system enables a double saving in terms of the heat and chemicals needed for the treatment. Furthermore, the natural filtering system guarantees, when using both stabilised and non-stabilised disinfectant products, that the swimming pool water is kept clean, clear and sparkling and does not smell of chlorine; this is done without the use of chemical additives.

The present invention applies to the sector for the treatment of water pools in general and swimming pools in particular and any other type of water purification plant for public or private use.

2. Background Art

It is well known that public and private swimming pools contain considerable amounts of water which require constant treatment to keep the water quality within the legally prescribed limits.

In general, for this purpose the filtration cycle involves drawing off the swimming pool water through bottom intakes and skimmers or by special collectors for swimming pools which employ skimming technology. The water arrives at the pump through separate pipes with valves, passes through the filter and returns to the swimming pool through feed outlets.

When the water passes through the filter it leaves behind the dirt and other substances in suspension. After a certain period of time after the start of the filtration cycle it is necessary to clean the filter of any dirt deposits which partly obstruct the passage of water through the filter.

In some cases sand filters are used and some models employ diatomaceous material. In these cases the filters have a backwashing system where the direction of circulation of the water is reversed in order to expel the filtered dirt into the drainage system.

On other models it is necessary to open the filter and clean the filter elements inside.

In general, traditional filtering systems, even those using active carbon or other means for accumulating impurities, cannot guarantee that the water is perfectly clean and free of all possible pathogens which are formed during the continuous use of a pool by large numbers of people. It is necessary therefore to constantly add a predetermined quantity of chlorine to the water; the chlorine remains in circulation.

Despite these systems, traditional swimming pools, especially those used by large numbers of the public are obliged to partially change the water at more or less frequent intervals in order to ensure that the values prescribed by current regulations are maintained.

Clearly, all these treatment and regeneration systems involve complex filters and other water treatment components and as a consequence involve considerable running costs; filters have to be changed at regular intervals, sanitising substances such as chlorine have to be constantly added to the water and new, fresh water has to be added to the pool to replace the water removed from the pool.

### DRAWINGS

Further features and advantages of the invention will become apparent from the description of an example embodiment which follows with reference to the annexed drawings, given purely by way of a non-limiting example, in which:

FIG. 1 shows a block diagram of the filtering equipment according to the present invention.

FIG. 2 shows a diagram of the compensation tank according to the present invention.

### DETAILED DESCRIPTION

The present invention provides a filtering system for swimming pools which is designed to eliminate or at least to reduce the drawbacks described above.

The present invention provides a filtering system for swimming pools which is very simple to make and which above all is as natural and ecological as possible since it treats the water with a cycle similar to that in nature where watercourses are purified by passing the water through sands and aggregates on the bed of the watercourse.

This is achieved by a filtering system for swimming pools whose characteristics are described in the main claim.

The dependent claims of the present invention describe advantageous embodiments of the invention.

The natural filtering system for swimming pool water or similar according to the present invention can be applied to existing plant and to newly constructed plant and has numerous advantages including the following:

Savings of approximately 70% of counter-current washes, or backwashing, in comparison with traditional plant. This reduces both the amount of water to be discharged into the drainage system and the amount of new water to be added.

A reduction in the number of backwashes as indicated in point 1 above, reduces the amount of water needed to replace the water discharged into the drainage system. This means that the temperature of the water is not lowered and less thermal power is therefore needed to keep the water at the required temperature.

The consumption of stabilised and non-stabilised disinfectant products is reduced by 50% because there are fewer backwashes and in particular because the filtration catchment area is so large that it allows the water to be kept free of solid bodies ensuring that the water stays clean. This means the chemical disinfectant added to the water is only required in order to keep chemical characteristics to within regulatory limits.

The presence of combined active chlorine is eliminated and it is therefore no longer necessary to treat the water with oxidising products. It is also no longer necessary to drain off large quantities of swimming pool water which would otherwise have to be replaced with fresh water from the mains water supply or from wells or other sources. This enables a two-fold saving since fewer chemicals and less heat is required to treat the water.

The natural filtering system according to the present invention keeps the water free from the smell of chlorine and ensures that the water stays clear and sparkling without the need for chemical additives.

The filtering system according to the present invention creates inside the compensation tank a natural basin of filtering sand which must be cleaned by backwashing.

In particular, the filtering system according to the present invention is designed to provide natural filtering of the water by employing gravity and has electric pumps to draw the water from the circuits provided for this purpose inside the compensation tank.

In this way the water drawn by the electric pumps follows a natural filtering path through a mass of sand and then through filters.

The filtering mass contained in the compensation tanks comprises microparticles of high-efficiency quartz sand although other materials available on the market designed for treating water can be used as alternatives to quartz sand.

For example, it is possible to make filtering masses with one layer with a granulometry of 0.4 to 0.8 mm, known as single layer, or filtering masses with multiple layers with various granulometries between 9 mm and 1 mm, known as multi-layer or filtering masses with multiple layers of quartz sand, anthracite, zeolite, expanded synthetic material and other materials, known together as heterogeneous masses. The amount of sand is calculated on the basis of the volume of the compensation tank and the total capacity circulated by the electric pumps.

Backwashing is performed using the electric pumps running the swimming pool water circulation equipment.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

### DESCRIPTION OF AN EXAMPLE EMBODIMENT

With reference to the annexed drawings, the numeral 10 indicates a complete swimming pool with skimming technology, a characteristic application of the natural filtering system for treating water according to the present invention which can be installed on new or existing plant for the treatment of swimming pools or similar.

This system is also suitable for treatment processes in other applications involving the use of water (for example, aqueducts, wells, drinking water purification plant, filtering plant for the collection of rain water, etc.) and is installed inside compensation tanks in the case of swimming pools or in storage tanks or decantation tanks for other applications.

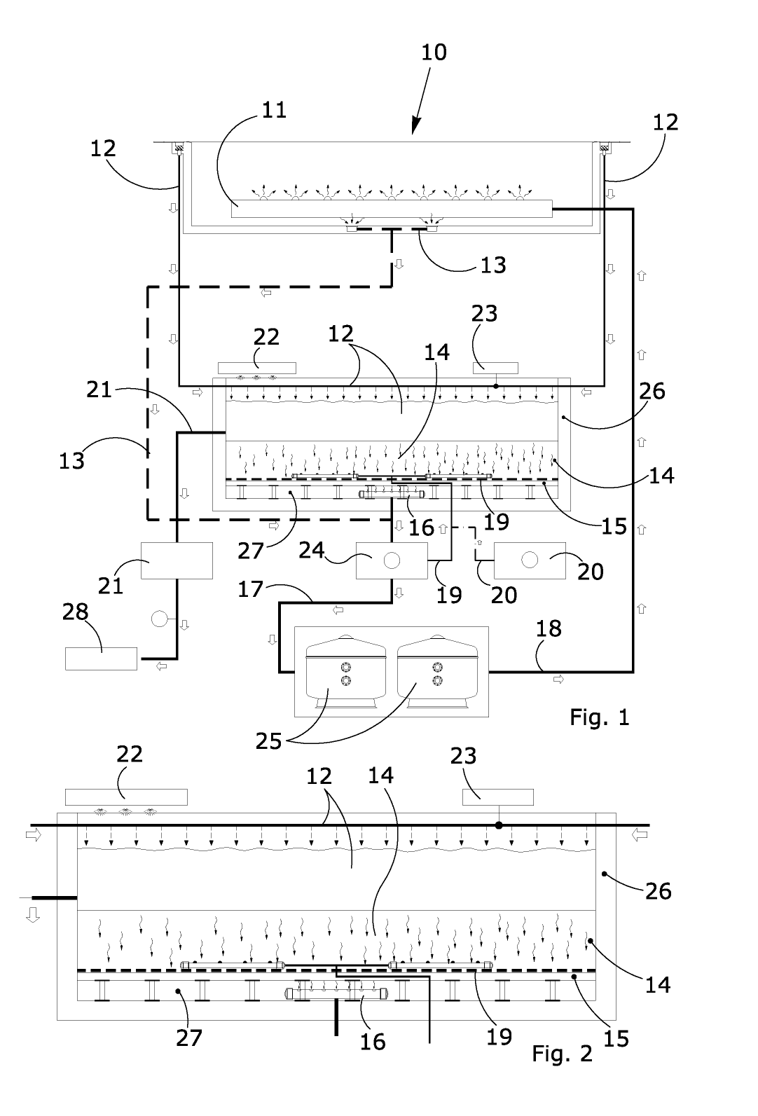

With reference to the diagram of the invention in FIG. 1, the numeral 11 indicates the feed outlet circuit loop in the swimming pool, the numeral 12 indicates the collection circuit for collecting water from the skimmer and spraying it into the compensation tank 26, the numeral 13 indicates the intake circuit at the bottom of the pool, the numeral 14 indicates the quartz sand or filtering mass, the numeral 15 indicates the polypropylene grill for supporting the filtering mass with a micromesh net and the numeral 16 indicates the filtered water manifold running along the entire surface of the compensation tank.

In FIG. 1 the numeral 17 indicates the filter pump connection circuit with the filter batteries, the numeral 18 indicates the filtered water infeed circuit to the pool, the numeral 19 indicates the backwashing circuit for washing the filtering mass, the numeral 20 indicates the air+water backwashing blowing circuit for washing the sand in combination with the water, the numeral 21 indicates the dirty water intake circuit for collecting the dirty water removed by backwashing and the numeral 22 indicates the disinfectant dispensing circuit for feeding in diluted, stabilised and non-stabilised disinfectants.

To continue with the description of the components shown in FIG. 1, the numeral 23 indicates the liquid pH corrector dispenser, the numeral 24 indicates the plant pumping circuit station, the numeral 25 indicates the pressure filters for the special treatment of fine water, the numeral 26 indicates the compensation tank, the numeral 27 indicates the volume of filtered water under the bed of sand supported by the plate and the numeral 28 indicates the backwashing water discharged by the filtering mass in the compensation tank.

The filtering system according to the present invention is designed to provide the natural filtering of water which is gravity fed to the circuit 12 from where electric pumps 24 draw the water from the circuits provided for this purpose inside the compensation tank 26.

In this way the water drawn by the electric pumps 24 follows a natural filtering path through a mass of sand 14 and filters 25, passing through a succession of components shown in the annexed drawing.

The filtering mass 14 contained in the compensation tanks 26 comprises microparticles of high-efficiency quartz sand.

It should be noted that it is possible to use other commercially available materials for the treatment of water as alternatives to quartz sand. For example, it is possible to make filtering masses with one layer with a granulometry of 0.4 to 0.8 mm, known as single layer, or filtering masses with multiple layers with various granulometry between 9 mm and 1 mm, known as multi-layer or filtering masses with multiple layers of quartz sand, anthracite, zeolite, expanded synthetic material and other materials, known together as heterogeneous masses.

The amount of sand is calculated on the basis of the volume of the compensation tank and the total capacity circulated by the electric pumps 24.

The water fed to the compensation tank 26 is sprayed uniformly over the entire surface of the tank thereby oxygenating the water and preventing the flow of water from disturbing the sand or forming it into heaps.

The filtering mass 14 is supported by a plate 15, extending over the entire surface of the compensation tank, formed by modular grills made from polypropylene material with dimensions of approximately 1,217×405 mm, and a mesh of 43×43 mm, complete with connectors for joining the modules covering the entire surface.

This plate 15 can be raised from the floor of the compensation tank to create a volume of filtered water under the mass of sand in the zone indicated by the numeral 27.

Resting on top of the plate 15 there is a micromesh net made from a high-density polypropylene material such as UV-stabilised PEHD with a single-strand tensile strength of 2.8 kg; the micromesh net allows the water to pass through but does not allow the filtering mass to pass through.

In the volume under the plate, that is, in zone 27, there are drilled branching manifolds 16 whose function is to collect the filtered water which has passed through the filtering mass.

These manifolds 16 are made from PVC material and have dimensions based on the capacity developed by the electric pumps circulating the water in the swimming pool.

The skimmed water fed into the compensation tank sprays down onto the filtering mass 14, through the intake circuit consisting of branched manifolds 16, located under the plate 15 and connected to the intake circuit of the electric pumps 24; the water follows a natural, unforced gravity-fed path through the filtering mass 14 where it is slowly filtered and cleaned of any solid bodies it might be carrying.

The water, after it has undergone a first natural filtering through the filtering mass 14, is next fed to the filters by the electric pumps which carry the water to the filters 25. Inside the filters the water is force fed by the pumps 24 under pressure and further filtered and then carried to the infeed circuits 18 connected to the outlets 11 at the bottom of the swimming pool floor.

Chemical conditioning in the form of disinfectant products and pH correctors is injected directly into the compensation tank.

The stabilised or non-stabilised disinfectant products, in liquid, solid or powder form, are fed into the compensation tank 26 through a dispenser 22. Liquid product is injected through a hydraulic circuit fed by dosing pumps which feed the disinfectant product into the compensation tank 26.

Disinfectant in solid or powder form is fed in directly using special containers.

pH correctors can be fed in through the piping which carries the skimmer water into the compensation tank by using injectors 23.

Inside the compensation tank 26 there is a natural basin of filtering sand 14 which is cleaned by backwashing. Backwashing is performed using the electric pumps 24 running the swimming pool water circulation equipment.

Waste material is removed from the filtering mass using a by-pass hydraulic operation whereby the water is drawn from the bottom intakes of the swimming pool and carried to the injectors 19 located above the plate.

The water assisted by air blowers with air produced by side channel compressors 20, removes the dirt held inside the filtering mass.

In this way the dirt is raised from the sand and is mixed with the water. The dirty water is collected by an intake circuit along the perimeter of the compensation tank with the aid of an electric pump 21 and is discharged into the drain 28.

The sand washing circuit comprises piping and connectors made from materials such as PVC and has nozzles which augment the action of the air and water mixture during backwashing to ensure that the dirt is removed efficiently.

The natural filtering system for swimming pool water can be applied to existing plant and to newly constructed plant and has the advantages already mentioned above, namely:

Savings of approximately 70% of counter-current washes, or backwashing, in comparison with traditional plant. This reduces both the amount of water to be discharged into the drainage system and the amount of new water to be added.

A reduction in the number of backwashes as indicated in point 1 above, reduces the amount of water needed to replace the water discharged into the drainage system. This means that the temperature of the water is not lowered and less thermal power is therefore needed to keep the water at the required temperature.

The consumption of stabilised and non-stabilised disinfectant products is reduced by 50% because there are fewer backwashes and in particular because the filtration catchment area is so large that it allows the water to be kept free of solid bodies ensuring that the water stays clean. This means the chemical disinfectant added to the water is only required in order to keep chemical characteristics to within regulatory limits.

The presence of combined active chlorine is eliminated and it is therefore no longer necessary to treat the water with oxidising products. It is also no longer necessary to drain off large quantities of swimming pool water which would otherwise have to be replaced with fresh water from the mains water supply or from wells or other sources. This enables a two-fold saving since fewer chemicals and less heat is required to treat the water.

The natural filtering system according to the present invention keeps the water free from the smell of chlorine and ensures that the water stays clear and sparkling without the need for chemical additives.

The invention as described above refers to a preferred embodiment. Naturally, while the principle of the invention remains the same, the details of construction and the embodiments may widely vary with respect to what has been described and illustrated purely by way of the example, without departing from the scope of the present invention.

1-10. (canceled)

11. A natural filtering system for the treatment of water of a structure constituted by a swimming pool and/or an aqueduct, a well, a drinking water purification plant, a filtering plant for the collection of rain water and the like, said structure comprising a main water tank and:
a) in the case of a swimming pool, at least a compensation tank, and
b) in the case of an aqueduct, a well, a drinking water purification plant, a filtering plant for the collection of rain water, a storage or decantation tank, said compensation tank and/or said storage or decantation tank having a predetermined volume and being used for receiving water coming from main water tanks for carrying out further filtration processes, wherein:
i) a filtration mass constituted by microparticles of high-efficiency quartz sand or similar or other material suitable for treating water is placed inside said compensation tank or said storage or decantation tank;
ii) a system of pipelines feeding water from the main tanks and spraying said water as a rain fall on the surface of said filtration mass is placed above said compensation tank or above said storage or decantation tank;
iii) a branched network of pipelines made of a synthetic material, i.e. PVC or PE, is placed on the bottom of said compensation tank or on the bottom of said storage or decantation tank, said pipelines being provided of suitable orifices allowing the passage of water filtered through said filtration mass, said pipelines being connected to a water suction circuit governed by electric pumps in order to recycle the filtered water towards the main water tank of said structure.

12. The system according to claim 11, in which said filtering mass comprises a single layer of quartz sand, anthracite, zeolite, expanded synthetic materials or heterogeneous masses or similar with a granulometry ranging between approximately 0.4 and 0.8 mm,

13. The system according to claim 11, in which said filtering mass comprises multiple layers with a granulometry ranging between approximately or filtering masses comprising multiple layers of quartz sand, anthracite, zeolite, expanded synthetic materials or heterogeneous masses or similar with a granulometry ranging between approximately 9 mm and 1 mm.

14. The system according to claim 11, characterised in that said filtering mass is supported by at least one plate extending over the entire surface of the compensation tank.

15. The system according to claim 14, in which said plate rests on at least a micromesh net made from high-density polyethylene PE.

16. The system according to claim 14, in which said plate can be raised from the floor of the compensation tank to create a volume of filtered water under the mass of sand in the zone.

17. The system according to claim 14, in which resting on top of the plate there is a micromesh net made from a high-density polypropylene material such as UV-stabilised PEHD with a single-strand tensile strength of approximately 2.8 kg, which allows the water to pass through but does not allow the filtering mass to pass through.

18. The system according to claim 11, in which a chemical conditioning in the form of disinfectant products and pH correctors is injected directly into said compensation tank through dispensers which feed product in liquid, solid or powder form into the compensation tank.

19. The system according to claim 18, in which liquid products are fed in through hydraulic circuits fed by dosing pumps, while solid or power products are fed in using containers fed with swimming pool water, and where the pH correctors can be fed into the piping which carries the skimmer water into the compensation tank with the aid of injectors.
